(19) United States
(12) Patent Application Publication
(10) Pub. No.: US 2006/0284854 A1
(43) Pub. Date: Dec. 21, 2006

(54) Cordless electromagnetic induction system and method for automatic wake up

(76) Inventors: Shih-Hao Cheng, Zhonghe City (TW); Chih-An Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/155,490

(22) Filed: Jun. 20, 2005

(51) Int. Cl. G09G 5/00

(52) U.S. Cl. 345/173

(57) ABSTRACT

The present invention discloses a cordless electromagnetic induction system, which comprises a cordless pen and a tablet connecting to a host. In this regards, the cordless pen comprises a battery for supplying power to the cordless pen, a radio frequency (RF) oscillation circuit for generating RF signal representing the location and status of the cordless pen, a wake up apparatus, and a sleep control apparatus. The wake up apparatus sets the cordless pen into a working mode and startup the RF oscillation circuit when receiving a wakeup RF signal. Moreover, the sleep control apparatus sets the cordless pen into a sleep mode and shutdown the RF oscillation circuit when the cordless pen is idle for a while in the working mode. In this embodiment, the tablet comprises a control apparatus, a tablet RF emitter, and a tablet RF receiver for receiving RF signal, representing the location and status of said cordless pen, from the RF oscillation circuit and informing the control apparatus. In this regards, the control apparatus starts up the tablet RF emitter when no RF signal from the RF oscillation circuit received, and shuts down the tablet RF emitter when RF signal from the RF oscillation circuit received.

### BACKGROUND OF THE INVENTION

1. Field of the Invention

The present invention generally relates to cordless electromagnetic induction pen and tablet, and more particularly to cordless electromagnetic induction system and method for automatic wake up.

2. Description of the Prior Art

Hand-writing recognition apparatus performs as well as computer mouse. Since it is more suitable for drawing and graphics operations than mouse, the development and improvement of hand-writing recognition apparatus is harvest in recent years. The earliest concept of hand-writing recognition apparatus is to replace mouse by pen. For the convenience, a cordless pen and a corresponding tablet is taken place of mouse. Therefore the left button of mouse is usually replaced by the tip of the cordless pen. Although this product is on the shelf for a few years, the normal applications of this kind of product are restricted in graphics and writing input.

Current hand-writing input product is usually a cordless electromagnetic induction system, which comprises a cordless pen with a battery and a tablet. Moreover, the cordless pen comprises an oscillation circuit composed by capacitor. Whenever the tip is touched or pressed, the capacitance would be changed accordingly. Hence the variation of oscillation frequency of the oscillation circuit is also changed in proportional to the difference of the capacitance. Therefore the pressure on the tip could be induced from the variation of oscillation frequency. Furthermore, there may be at least one button on the side of the cordless pen. By the way, the capacitance of the oscillation circuit is also changed according to the status of the button. Therefore the press of the button could be induced from the variation of oscillation frequency. In the other hands, the tablet comprises several components such as detectors, amplifiers, and ADC (analog to digital converter). The central working area of the tablet is the sensor circuit, which comprises arrayed receiving antenna in double sides. The main purpose of the receiving antenna is to receive RF (radio frequency) signal of the corresponding cordless pen, merely. Whenever the pen radiated some RF signal, it would be picked up by the receiving antenna and be translated into some useful information by the tablet.

No matter the battery of the cordless pen is rechargeable or not, the battery power is limited. Accordingly, the traditional cordless pen has a sleep control apparatus for making the cordless pen into sleep mode after a period of idle. Situated in sleep mode, the cordless pen does not emit any radio frequency signal. When user wants to wake up the cordless pen in sleep mode, user has to press the button or the tip in order to cause capacitance variation for waking the pen up. However, the user often forget doing that steps and start expecting the movement of cursor is corresponding to the movement of the cordless pen. In this circumstance, since no RF signal is emitted by the sleeping pen, the location of the cordless pen cannot be detected by the tablet. In the consequence, the cursor would not be moved in proportional to the pen. When system response does not meet the user expectation, user may consider that the battery power is out or the hand-writing system is mal-functioned. Hence the present invention discloses a cordless electromagnetic induction system and method for automatic wake up in order to prevent the mentioned misunderstandings.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

One object of the present invention is to disclose a cordless electromagnetic induction system, which comprises a cordless pen and a tablet connecting to a host. In this regards, the cordless pen comprises a battery for supplying power to the cordless pen, a radio frequency (RF) oscillation circuit for generating RF signal representing the location and status of the cordless pen, a wake up apparatus, and a sleep control apparatus. The wake up apparatus sets the cordless pen into a working mode and startup the RF oscillation circuit when receiving a wakeup RF signal. Moreover, the sleep control apparatus sets the cordless pen into a sleep mode and shutdown the RF oscillation circuit when the cordless pen is idle for a while in the working mode. In this embodiment, the tablet comprises a control apparatus, a tablet RF emitter, and a tablet RF receiver for receiving RF signal, representing the location and status of said cordless pen, from the RF oscillation circuit and informing the control apparatus. In this regards, the control apparatus starts up the tablet RF emitter when no RF signal from the RF oscillation circuit received, and shuts down the tablet RF emitter when RF signal from the RF oscillation circuit received.

Another object of the present invention is to disclose a cordless electromagnetic induction method. First, a cordless electromagnetic induction system, which comprises a cordless pen and a tablet connecting to a host, is provided in the method. In this regards, the cordless pen comprises a battery for supplying power to the cordless pen, a RF oscillation circuit for generating RF signal representing the location and status of the cordless pen, a wake up apparatus, and a sleep control apparatus. In this embodiment, the tablet comprises a control apparatus, a tablet RF emitter, and a tablet RF receiver for receiving RF signal, representing the location and status of said cordless pen, from the RF oscillation circuit and informing the control apparatus. In this regards, the method further comprises setting said cordless pen into a working mode and starting up the RF oscillation circuit, by the wake up apparatus, when the wakeup RF signal received, and shutting down the tablet RF emitter, by said control apparatus, when RF signal from the RF oscillation circuit is received.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1A is a block diagram illustrates a cordless electromagnetic induction system for automatic wake up;

FIG. 1B and FIG. 1C are diagrams show the position of a tablet RF emitter of the tablet;

FIG. 2 shows a flowchart diagram of the cordless electromagnetic induction system shown in the FIG. 1A;

FIG. 3 shows a block diagram of a cordless electromagnetic induction system for automatic wake up of another embodiment in accordance with the present invention; and

FIG. 4 shows a flowchart diagram of the cordless electromagnetic induction system shown in the FIG. 3.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

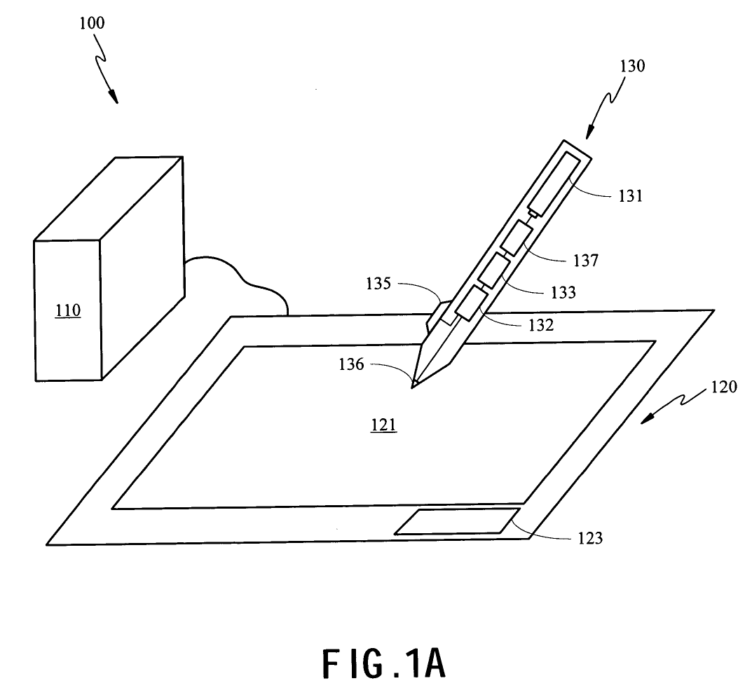

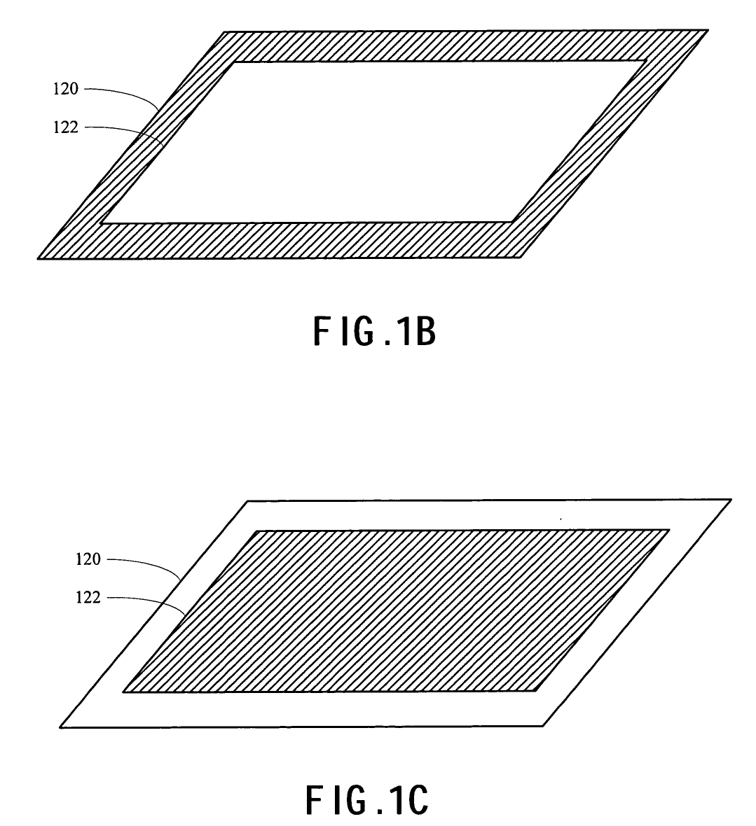

Please refer to FIG. 1A, which shows a block diagram of a cordless electromagnetic induction system 100 for automatic wake up. The system 100 comprises a tablet 120, connecting to a host 110, and a cordless pen 130. In this regards, the cordless pen 130 comprises a battery 131, supplying power to this cordless pen 130, a RF oscillation circuit 132, a sleep control apparatus 133, at least one button 135, a tip 136, and a wake up apparatus 137. The button 135 and the tip 136 are connected to the RF oscillation circuit 132. When the button 135 and/or the tip 136 are pressed, the emitted frequency of the RF oscillation circuit 132 would be changed accordingly. Therefore a tablet RF receiver 121 of the tablet 120 could translate the status and pressure level of the button 135 and/or the tip 136 according to the frequency emitted by the RF oscillation circuit 132.

Moreover, while an idle period is passed on the cordless pen 130, the sleep control apparatus 133 would enforce the cordless pen into a sleep mode for saving power. In sleep mode, when the button 135 and/or the tip 136 are pressed, the wake up apparatus 137 would wake the cordless pen up restoring a normal working mode.

Please refer to FIG. 1B and FIG. 1C, which are diagrams showing the position of a tablet RF emitter 122 of the tablet 120. In an example shown in the FIG. 1B, the tablet 120 further comprises a tablet RF emitter 122 surrounding the edges of the tablet 120. In other words, the tablet RF emitter 122 is put in the perimeter of the central working area. In another example shown in the FIG. 1C, the tablet RF emitter 122 is located in the central working area of the tablet 120. In this regards, the tablet 120 further comprises a control apparatus 123 connecting to the tablet RF receiver 121 and the tablet RF emitter 122. When the tablet RF receiver 121 receives no RF signal from the cordless pen 130, the control apparatus 123 would consider that the cordless pen has entered the sleep mode. Therefore the tablet RF emitter 122 would radiate a RF signal with proper field strength. Furthermore, the wake up apparatus 137 of the cordless pen 130 could receive the RF signal of the tablet RF emitter 122 in a proper distance. When the cordless pen 130 is in the sleep mode, the wake up apparatus 137 would wake up this pen 130 and restoring it into the normal working mode after receiving the RF signal. In this regards, the tablet RF emitter 122 would be shutdown by the control apparatus 123 after the signal from the oscillation circuit 132 is received by the tablet RF receiver 121. In one example of the embodiment, the control apparatus 123 is a control circuit of the tablet 120. In another example of the embodiment, the control apparatus 123 is driver software on the host 110 for controlling the tablet 120. The present invention does not restrict the implementation of the control apparatus 123.

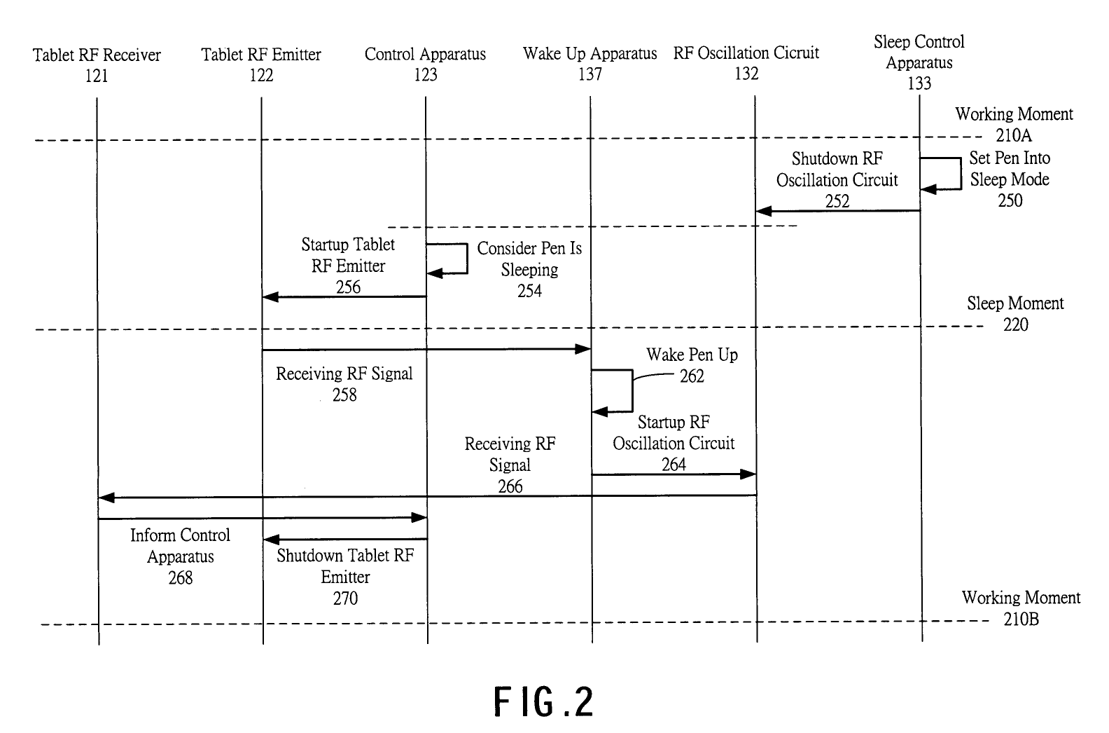

Please refer to FIG. 2, which shows a flowchart diagram of the cordless electromagnetic induction system 100 shown in the FIG. 1A. In this FIG. 2, the tablet RF receiver 121, the tablet RF emitter 122, and the control apparatus 123 of the tablet 120 as well as the sleep control apparatus 133, the RF oscillation circuit 132, and the wake up apparatus 137 of the cordless pen 130 are shown. In a working moment 210A, the RF oscillation circuit 132 emits RF signal continuously and the tablet RF emitter 122 remains silence. After staying in idle for a while, the sleep control apparatus 133 sets the cordless pen 130 into sleep mode in step 250 and shutdown the RF oscillation circuit 132 in the following step 252. In this regards, since no RF signal from the RF oscillation circuit 132 could be received, the control apparatus 123 judges that the cordless pen is felt in sleep mode in step 254 and startup the tablet RF emitter 122 in step 256.

As shown in the FIG. 2, at the sleep moment 220, the sleeping cordless pen 130 would sleep continuously where it is apart from the tablet 120 beyond a distance. Once the user tries to use the cordless pen 130, it would be moved on the tablet 120. During this approach, the RF signal emitted by the tablet RF emitter 122 would be received by the wake up apparatus 137 in step 258. Next, in the step 262, the cordless pen 130 would be waked up by the wake up apparatus 137. In the following step 264, the RF oscillation circuit 132 would be functioned. When the RF signal emitted by the RF oscillation circuit 132 is received in step 266, the tablet RF receiver 121 of the tablet 120 informs the control apparatus 123 in the next step 268. Accordingly, the control apparatus 123 shuts the tablet RF emitter 122 in the following step 270. At this working moment 210B, the RF oscillation circuit 132 emits RF signal continuously and the tablet RF emitter 122 still remains silence.

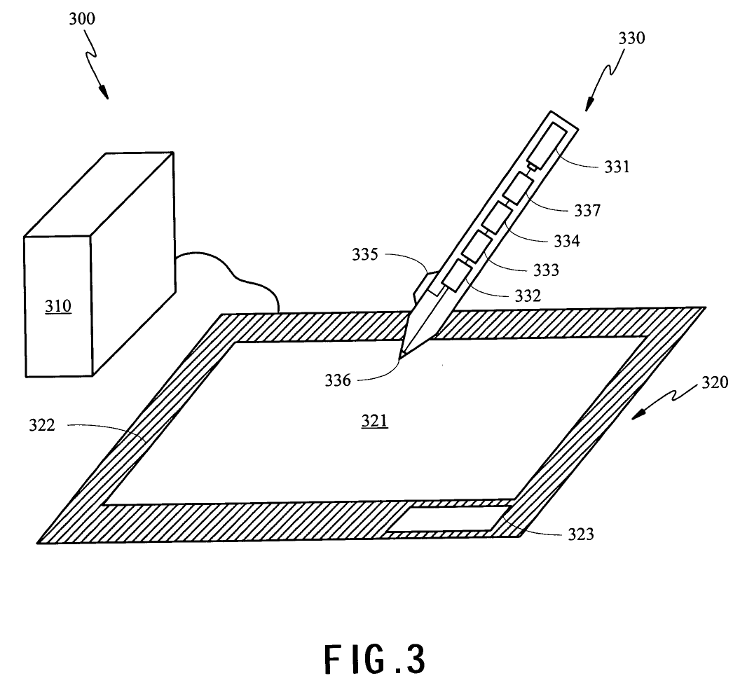

Please refer to FIG. 3, which shows a block diagram of a cordless electromagnetic induction system 300 for automatic wake up of another embodiment in accordance with the present invention. The system 300 comprises a tablet 320, connecting to a host 310, and a cordless pen 330. In this regards, the cordless pen 330 comprises a battery 331, supplying power to this cordless pen 330, a RF oscillation circuit 332, a sleep control apparatus 333, at least one button 335, a tip 336, a wake up apparatus 137, and a attitude detection apparatus 134 connecting to the wake up apparatus 137. The button 335 and the tip 336 are connected to the RF oscillation circuit 332. When the button 335 and/or the tip 336 are pressed, the emitted frequency of the RF oscillation circuit 332 would be changed accordingly. Therefore a tablet RF receiver 321 of the tablet 320 could translate the status and pressure level of the button 335 and/or the tip 336 according to the frequency emitted by the RF oscillation circuit 332.

In this regards, the tablet 320 further comprises a tablet RF emitter 322 and a control apparatus 323 connecting to the tablet RF receiver 321 and the tablet RF emitter 322. When the tablet RF receiver 321 receives no RF signal from the cordless pen 330, the control apparatus 323 would consider that the cordless pen has entered the sleep mode. Therefore the tablet RF emitter 322 would radiate a RF signal with proper field strength. Furthermore, the wake up apparatus 337 of the cordless pen 330 could receive the RF signal of the tablet RF emitter 322 in a proper distance. When the cordless pen 330 is in the sleep mode and a hand-holding attitude detected by the attitude detection apparatus 334, the wake up apparatus 337 would wake up this pen 330 and restoring it into the normal working mode after receiving the RF signal. In this regards, the tablet RF emitter 322 would be shutdown by the control apparatus 323 after the signal from the oscillation circuit 332 is received by the tablet RF receiver 321.

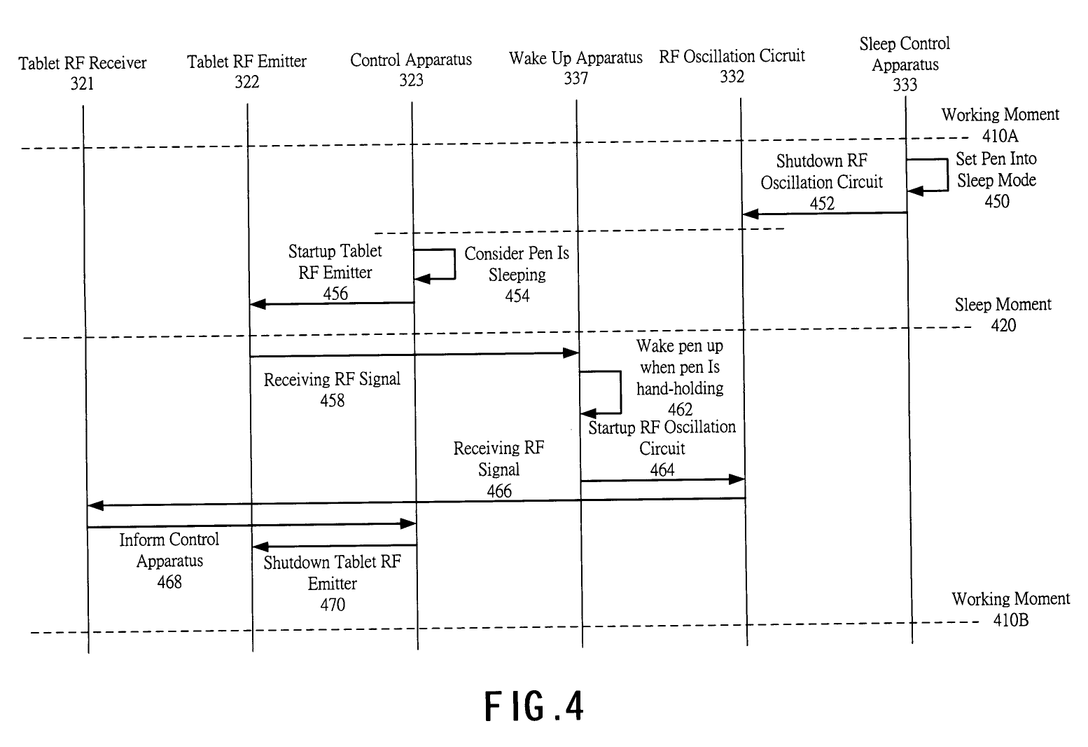

Please refer to FIG. 4, which shows a flowchart diagram of the cordless electromagnetic induction system 300 shown in the FIG. 3. In this FIG. 4, the tablet RF receiver 321, the tablet RF emitter 322, and the control apparatus 323 of the tablet 320 as well as the sleep control apparatus 333, the RF oscillation circuit 332, and the wake up apparatus 337 of the cordless pen 330 are shown. In a working moment 410A, the RF oscillation circuit 332 emits RF signal continuously and the tablet RF emitter 322 remains silence. After staying in idle for a while, the sleep control apparatus 333 sets the cordless pen 330 into sleep mode in step 450 and shutdown the RF oscillation circuit 332 in the following step 452. In this regards, since no RF signal from the RF oscillation circuit 332 could be received, the control apparatus 323 judges that the cordless pen is felt in sleep mode in step 454 and startup the tablet RF emitter 322 in step 456.

As shown in the FIG. 4, at the sleep moment 420, the sleeping cordless pen 330 would sleep continuously where it is apart from the tablet 320 beyond a distance. Once the user tries to use the cordless pen 330, it would be moved on the tablet 320. During this approach, the RF signal emitted by the tablet RF emitter 322 would be received by the wake up apparatus 337 in step 458. Next, in the step 462, the cordless pen 330 would be waked up by the wake up apparatus 337 when the attitude detection apparatus 334 detects that the cordless pen 330 is in hand-holding attitude. In the following step 464, the RF oscillation circuit 332 would be functioned. When the RF signal emitted by the RF oscillation circuit 332 is received in step 466, the tablet RF receiver 321 of the tablet 320 informs the control apparatus 323 in the next step 468. Accordingly, the control apparatus 323 shuts the tablet RF emitter 322 in the following step 470. At this working moment 410B, the RF oscillation circuit 332 emits RF signal continuously and the tablet RF emitter 322 still remains silence.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A cordless electromagnetic induction system, comprising:
a cordless pen, wherein said cordless pen comprising:
a battery for supplying power to said cordless pen;
a radio frequency (RF) oscillation circuit for generating RF signal representing the location and status of said cordless pen;
a wake up apparatus for setting said cordless pen into a working mode and startup said RF oscillation circuit when receiving a wakeup RF signal; and
a sleep control apparatus for setting said cordless pen into a sleep mode and shutdown said RF oscillation circuit when said cordless pen is idle for a while in said working mode; and
a tablet, connecting to a host, comprising:
a tablet RF receiver for receiving RF signal, representing the location and status of said cordless pen, from said RF oscillation circuit and informing a control apparatus;
a tablet RF emitter; and
said control apparatus, wherein said control apparatus starts up said tablet RF emitter when no RF signal from said RF oscillation circuit received, and shuts down said tablet RF emitter when RF signal from said RF oscillation circuit received.

2. A cordless electromagnetic induction system of claim 1, wherein said cordless pen further comprising a tip, connecting to said RF oscillation circuit, said RF oscillation circuit generates RF signal representing the status of said tip.

3. A cordless electromagnetic induction system of claim 1, wherein said cordless pen further comprising a button, connecting to said RF oscillation circuit, said RF oscillation circuit generates RF signal representing the status of said button.

4. A cordless electromagnetic induction system of claim 2, wherein said wake up apparatus sets said cordless pen into said working mode and starts said RF oscillation circuit up after informed that the changed status of said tip by said RF oscillation circuit.

5. A cordless electromagnetic induction system of claim 3, wherein said wake up apparatus sets said cordless pen into said working mode and starts said RF oscillation circuit up after informed that the changed status of said button by said RF oscillation circuit.

6. A cordless electromagnetic induction system of claim 1, wherein said tablet RF emitter is located at the perimeter of central working area of said tablet.

7. A cordless electromagnetic induction system of claim 1, wherein said tablet RF emitter is located at the central working area of said tablet.

8. A cordless electromagnetic induction system of claim 1, wherein said cordless pen further comprises an attitude detection apparatus, connecting to said wake up apparatus, said wake up apparatus sets said cordless pen into said working mode and startup said RF oscillation circuit when receiving a wakeup RF signal and detecting said cordless pen is in a hand-holding mode by said attitude detection apparatus.

9. A cordless electromagnetic induction method, comprising:
providing a cordless electromagnetic induction system, wherein said system comprising:
a cordless pen, wherein said cordless pen comprising:
a battery for supplying power to said cordless pen;
a radio frequency (RF) oscillation circuit for generating RF signal representing the location and status of said cordless pen;
a wake up apparatus for receiving a wakeup RF signal; and
a sleep control apparatus for controlling said RF oscillation circuit; and
a tablet, connecting to a host, comprising:
a tablet RF receiver for receiving RF signal, representing the location and status of said cordless pen, from said RF oscillation circuit and informing a control apparatus;
a tablet RF emitter; and
said control apparatus for controlling said tablet RF emitter;
setting said cordless pen into a working mode and starting up said RF oscillation circuit, by said wake up apparatus, when said wakeup RF signal received; and
shutting down said tablet RF emitter, by said control apparatus, when RF signal from said RF oscillation circuit is received.

10. A cordless electromagnetic induction method of claim 9, wherein said cordless pen further comprising a tip, connecting to said RF oscillation circuit, said RF oscillation circuit generates RF signal representing the status of said tip.

11. A cordless electromagnetic induction method of claim 9, wherein said cordless pen further comprising a button, connecting to said RF oscillation circuit, said RF oscillation circuit generates RF signal representing the status of said button.

12. A cordless electromagnetic induction method of claim 10, wherein said wake up apparatus sets said cordless pen into said working mode and starts said RF oscillation circuit up after informed that the changed status of said tip by said RF oscillation circuit.

13. A cordless electromagnetic induction method of claim 11, wherein said wake up apparatus sets said cordless pen into said working mode and starts said RF oscillation circuit up after informed that the changed status of said button by said RF oscillation circuit.

14. A cordless electromagnetic induction method of claim 9, wherein said tablet RF emitter is located at the perimeter of central working area of said tablet.

15. A cordless electromagnetic induction method of claim 9, wherein said tablet RF emitter is located at the central working area of said tablet.

16. A cordless electromagnetic induction method of claim 9, further comprising:
setting said cordless pen into a sleep mode and shutting down said RF oscillation circuit, by said sleep control apparatus, when said cordless pen is idle for a while in said working mode; and
starting up said tablet RF emitter, by said control apparatus, when no RF signal from said RF oscillation circuit received.

17. A cordless electromagnetic induction method of claim 9, wherein said cordless pen further comprises an attitude detection apparatus, connecting to said wake up apparatus, said wake up apparatus sets said cordless pen into said working mode and startup said RF oscillation circuit when receiving a wakeup RF signal and detecting said cordless pen is in a hand-holding mode by said attitude detection apparatus.
